(19) United States
(12) Patent Application Publication
(10) Pub. No.: US 2014/0298620 A1
(43) Pub. Date: Oct. 9, 2014

(54) Punchless Binder Apparatus

(71) Applicant: David Han Yoon, Los Angeles, CA (US)

(72) Inventor: David Han Yoon, Los Angeles, CA (US)

(21) Appl. No.: 14/247,555

(22) Filed: Apr. 8, 2014

Related U.S. Application Data
(60) Provisional application No. 61/809,642, filed on Apr. 8, 2013.

(51) Int. Cl. B42F 1/00

(52) U.S. Cl. CPC B42F 1/006
USPC 24/67.9

(57) ABSTRACT

A binder system is disclosed that flexibly secures one or more flat objects including by mechanical grasping of flat-shaped or sheet materials in a central spring clamp having a compact cross-sectional geometry that can adapt to several sizes of clamped materials and uses. In some aspects the spring clamp comprises an elongated tri-folded rail with a flat central portion and aids a user in opening and keeping the system in its open configuration. In other aspects the system includes customizable covers attachable to said central spring clamp.

The present application is related to and claims the benefit and priority of U.S. Provisional Application No. 61/809,642, entitled “Punchless Paper Binder,” filed on Apr. 8, 2013, which is hereby incorporated by reference.

### TECHNICAL FIELD

The present application relates to the securement of objects such as sheet materials and other stackable, paper stock, film, or generally flat or compact items in a mechanical binder without requiring punching or drilling or otherwise defacing or modification of the objects to be secured.

### BACKGROUND

Sheet materials such as loose leaf sheets of paper and similar thin stackable materials can be organized and kept in binders of many types. Some binder systems include so-called “three-ring binder” systems consisting of a central spine or hinge apparatus having a plurality (e.g., three) articulated split rings that thread into corresponding holes punched into an edge of the papers to be bound, then the binder rings are snapped shut to form a closed ring shape enclosing and securing the punched papers. Other systems include a pinching mechanism that applies mechanical frictional force to pinch a plurality of sheets between two sides of a clamp. Still other types of binders, sometimes called “spiral notebooks” require drilling many small holes into an edge of the sheets, and then a metal or plastic spiral element is threaded into the small holes all along the drilled edge of the sheets to form a notebook of said sheets. Soft or hard covers can be added to either side of the stack of bound sheets for protection of the sheets against wear and tear.

Most existing binder systems require physical marking or punching or drilling or perforating of the bound sheets such as in the case of three-ring binders. Additionally, most existing notebook systems do not allow a user to configure the contents or their order such as in the case of spiral notebooks systems. Some clamping type binders exist but these are generally too bulky, have non-ideal clamp geometries, and are not flexible for multiple types of use. Other pinching type systems are not mechanically robust and are only suitable for light-weight temporary report formats for a limited number of sheets.

FIG. 1 illustrates a clasp style paper binding system which can be used to secure a few thin sheets such as a few sheets of paper in a report, memo or similar document. The binder consists of substantially an elongated clasp 100 typically made of bendable polymer material such as a hard plastic. The clasp 100 includes a c shaped cross section having a closed end 102 and an opposing openable end 104. One or more thin sheet stock material 110 can be inserted at a first edge 112 thereof into the clasp 100 through the openable end 104. Thin sheets 110 are secured on one edge thereof referred to as a bound edge 112 and an opposing unbound edge 114 allows a user to flip through the one or more sheets 110. Such clasp style binders are relatively inexpensive and compact, yet they are only suitable for a small number of sheets 110 and cannot withstand excessive mechanical force or stress as this would damage or open clasp 100 causing the sheets to be discharged there from and lost or damaged. Furthermore, this type of binder is limited by the material construction and dimensions of clasp 100, which is usually a thin plastic material and only suitable for basic applications such as containing a few sheets of a report or a memo or other short documents.

FIG. 2 illustrates another type of paper binding according to the prior art. Spring-action binder 200 includes a pair of openable cover panels 202 made of a relatively rigid material such as strong cardboard. The cardboard sides are bound to a spring-loaded tubular spine 210. The tubular spine 210 has a closed rounded back 211 and a pinched openable mouth 212 when viewed in cross section and defines an air gap 214 within the tubular spine 210.

The spring-action binder 200 is operated by spreading apart the two cover panels 202. This causes the spring-loaded spine 210 to expand in cross section at its pinched openable portion 212 can be pried apart to accommodate a plurality of sheets that are subsequently pinched to secure them in the binder 200.

Binder 200 designs suffer from the bulky design of the spring-loaded tubular spine members 210, especially when coupled with conventional binder cover materials 202. The cross-sectional size of binder spine 210 is larger than desired for most personal use applications, which cause the binder to be about one inch or more in girth no matter how few sheets are secured therein. Also, the curved back 211 of binder spine 210 of FIG. 2 is not conducive to placement of the binder on its back when in an open configuration during use. So these binder types are not convenient for users to open and write or read the contents thereof such as a user might do with an ordinary hard-covered book. The binders of FIG. 2 tend to flop around on their backs from side to side, or rock from side to side when opened and placed on a flat surface such as a table top. Additionally, binder 200 is not conducive to annotations to be made on the exterior of its spine 210 because this spine has a rounded profile 211. Finally, such binders are not ideally suited for archiving on a shelf in a series of continuous binders of this sort, as their bindings 210 do not sit uniformly side by side in a tidy manner, and have different appearance from one to the next depending on the number of sheets placed into binder 200.

### SUMMARY

As stated above, conventional binders typically require alteration or damage to the sheets being secured. In many instances, it is not desirable to damage or alter the sheets. Existing methods that do not require punching or drilling of the secured sheets however have other detracting features, for example poor durability, usability or aesthetic designs.

One or more embodiments hereof are directed to a binder for mechanically securing one or more objects therein, comprising an elongated stress-operated clamping rail configured to have a tri-folded cross-section comprising a flat center section and two flat opposing side sections; said side sections joined to said center section at a pair of respective elongated vertices defining respective outer edges of said center section and proximal edges of said side sections where said side sections meet said center section; said side sections further having respective distal edges away from said center section separated by a natural gap when in an unloaded position such as when no objects are within said clamping rail; and said tri-folded cross-section having an open end defined by said natural gap between said two distal edges of said side sections for receiving said objects, and an opposing closed end defined by said center section acting as a rigid spine of said clamping rail.

The claimed binder secures one or more sheets of material in a clamping rail that can be integrated with binder covers or other features to form a usable, durable, economical system for holding the sheets without damaging or puncturing them.

### IN THE DRAWINGS

Various embodiments of this invention are described below with reference to the accompanying drawings, in which:

FIG. 1 illustrates a plastic pinching report folder according to the prior art;

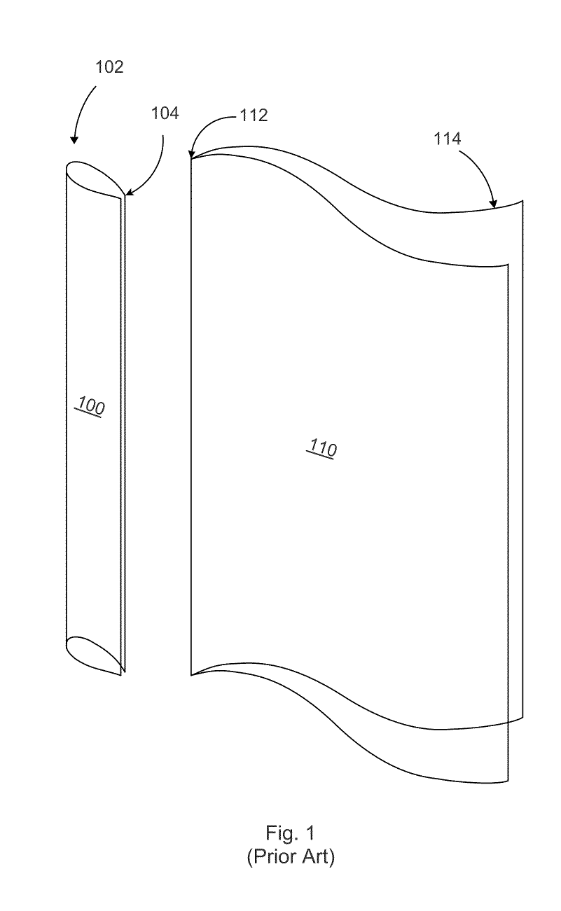

FIG. 2 illustrates a spring loaded tubular spine binder with hard covers according to the prior art;

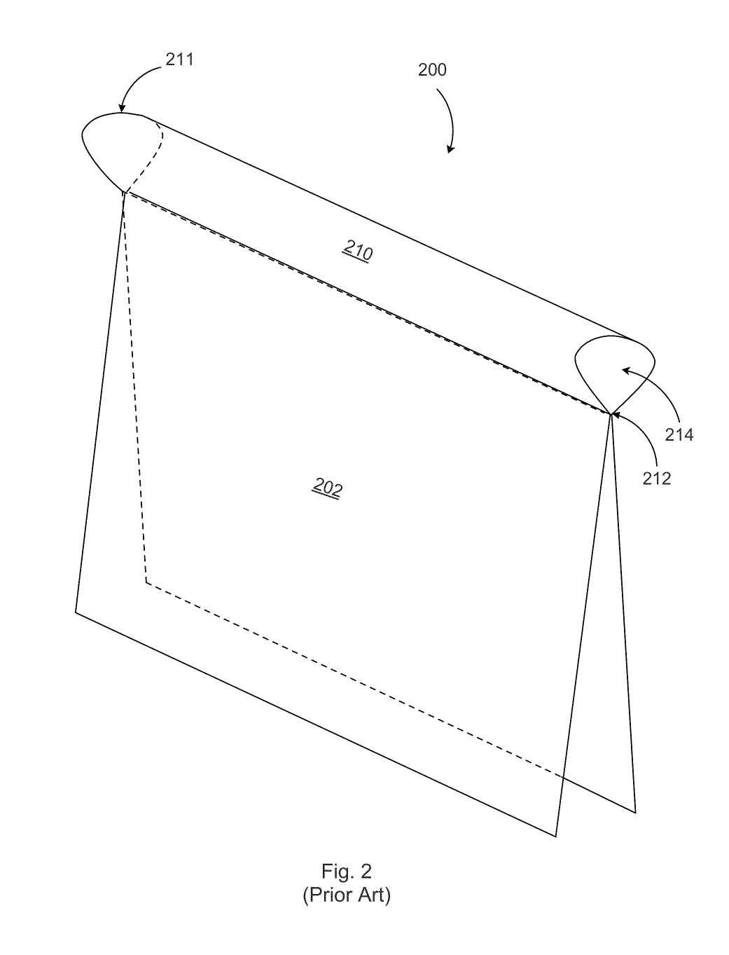

FIG. 3 illustrates an exemplary and tri folded clamping rail according to the present invention;

FIG. 4 illustrates a cross sectional view of an exemplary clamping rail according to the present invention;

FIG. 5 illustrates dimensional views of a clamping rail according to the present invention;

FIG. 6 illustrates a cross sectional view of a clamping rail in its loaded and unloaded configurations;

FIG. 7 illustrates an exemplary clamping rail and stack of sheet material to be inserted therein;

FIG. 8 illustrates the scenario of the previous figure with the clamping rail opened to accept the sheets;

FIG. 9 illustrates the clamping rail in its loaded configuration containing a plurality of sheets and;

FIG. 10 illustrates a loaded binder having a clamping rail and having covers applied around the loaded sheets in addition to exemplary closure mechanisms for use to keep the binder closed.

### DETAILED DESCRIPTION

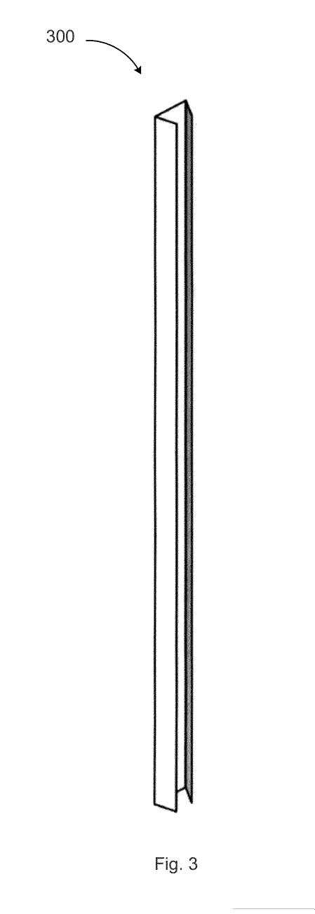

FIG. 3 illustrates an exemplary elongated clamping rail 300 that can be used to bind a variety of sheet stock or other objects, including paper, plastic sheets, photographs, film, or other sheet material. The elongated clamping rail 300 can be made of a longer stock that is cut to length at one or both ends. For example, the length of said elongated camping rail may be approximately the size of standard paper stock, or slightly longer to accommodate binding of the same. This includes lengths made to be used with binding US Letter, A4, Legal, or other standardized sheets. The clamping rail center section can be made of different dimensions or widths so as to accommodate various sizes of objects to be secured, or to accommodate various numbers of sheets to be secured therein.

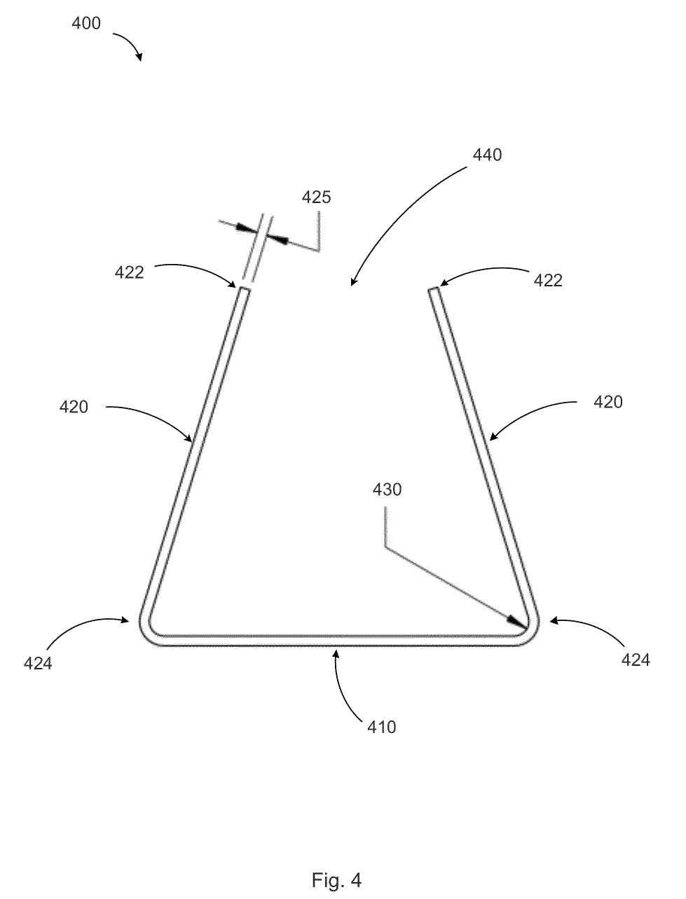

FIG. 4 shows an exemplary cross section 400 of the clamping rail 300 of the previous drawing. The rail structure is comprised of three primary facets including a center section 410 and two side sections 420 connected to center section 410 at a pair of respective folds, bends, seams, joints or creases 424 that are discussed further below. An interior angle 430 is formed between said center section 410 and each side section 420. In some embodiments, the angle 430 can be between 45 degrees and 90 degrees in its natural unstressed (unloaded) configuration, meaning when at rest and not stretched to hold anything. In some embodiments, the angle 430 can be between 60 degrees and 90 degrees in its unloaded configuration. In an embodiment, the interior angle can be between 70 and 80 degrees. In yet another embodiment, the interior angle 430 between said center section 410 and said side section 420 is approximately 73 degrees. The connection between center section 410 and side section 420 at fold 424 creates a three-sided profile of said rail, having two bends or folds or creases or joints 424 corresponding to each of said side sections 420 and is sometimes referred to as a tri-fold configuration. This configuration defines a closed end of the rail 400 defined by said center section 410 and an opposing open end 440 into which sheet stock is to be loaded during use. In other words, each side section 420 is firmly joined to an edge of said center section 410 at a corresponding joint line 424, but has an edge 422 distal from said center section surrounding and defining the opening 440.

The clamping rail is preferably constructed of a solid yet slightly flexible material such as stainless steel, aluminum, a composite, a very hard polymer or similar substance that is compact yet strong enough to serve the present function durably and without undue degradation, including repeated opening and closing duty which loaded to carry a plurality of sheet stock in a portable binder device. In an embodiment, the clamping rail is made of half hardened 301 stainless steel of a thickness 425 to be described further below. The other dimensions of the clamping rail 300 will be described in the context of preferred embodiments and configurations further below. In all cases, these dimensions are not intended to be limiting to the present invention, but are illustrative and preferred for the illustrated examples. Those skilled in the art can appreciate variations from the specific examples disclosed.

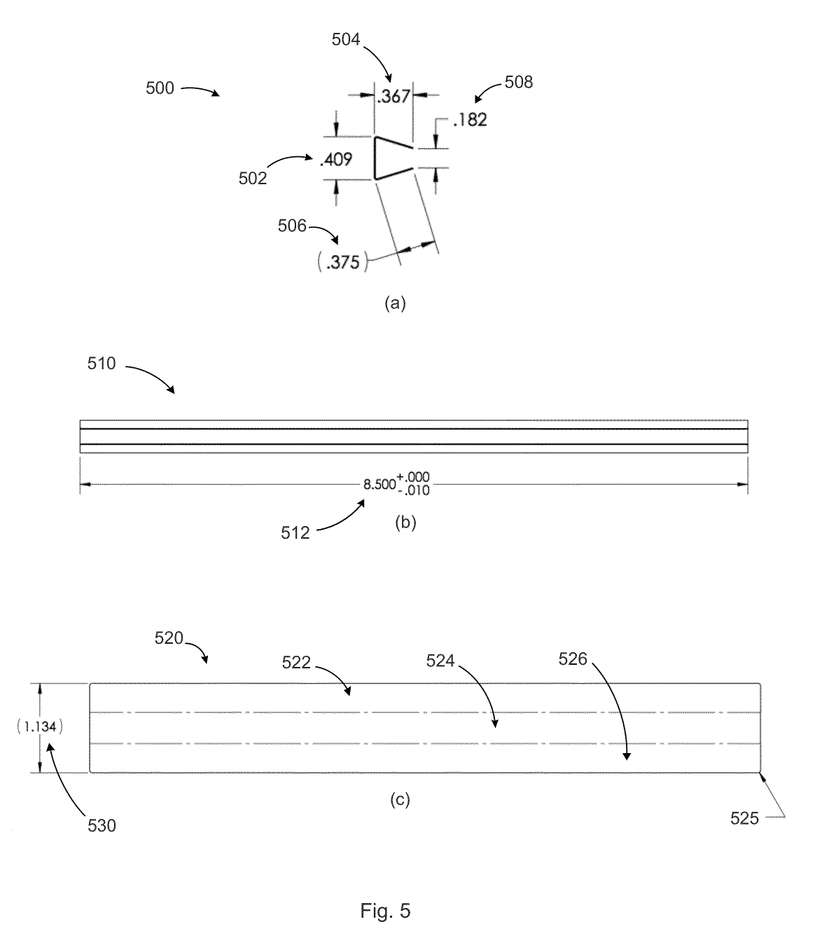

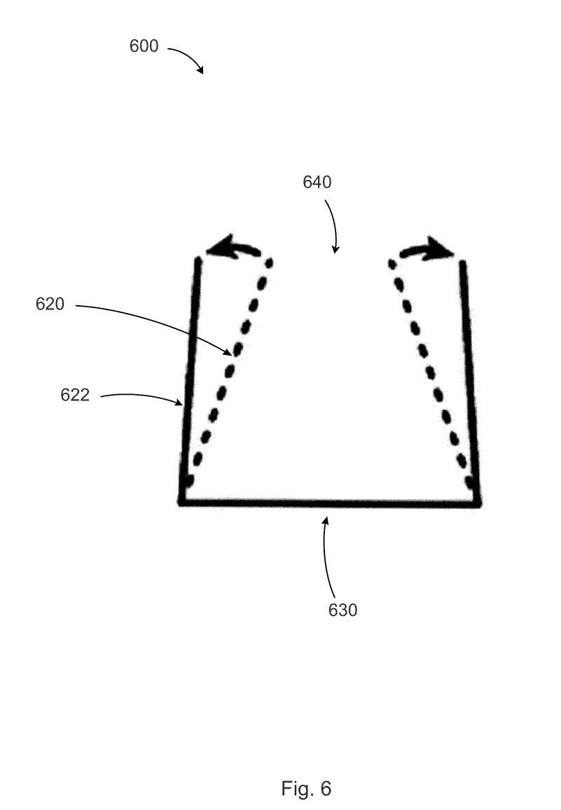

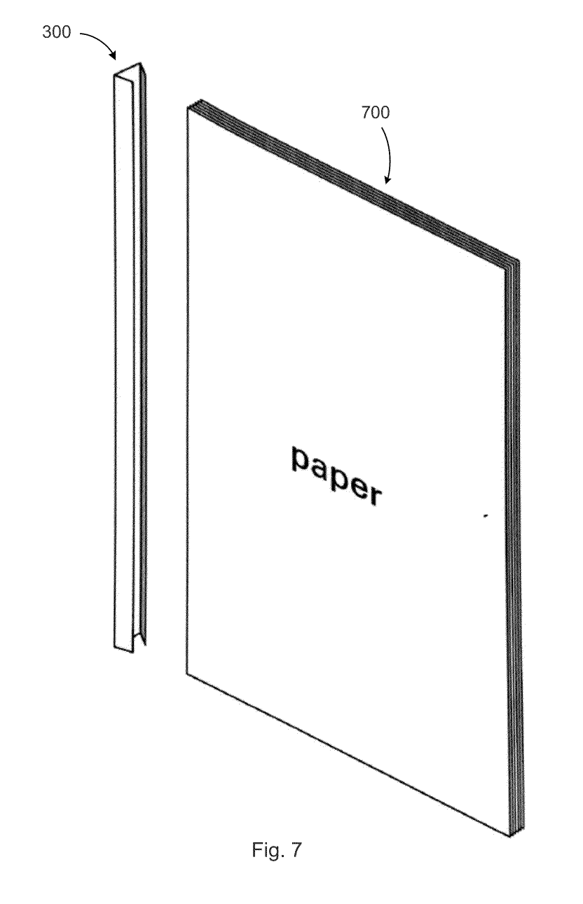

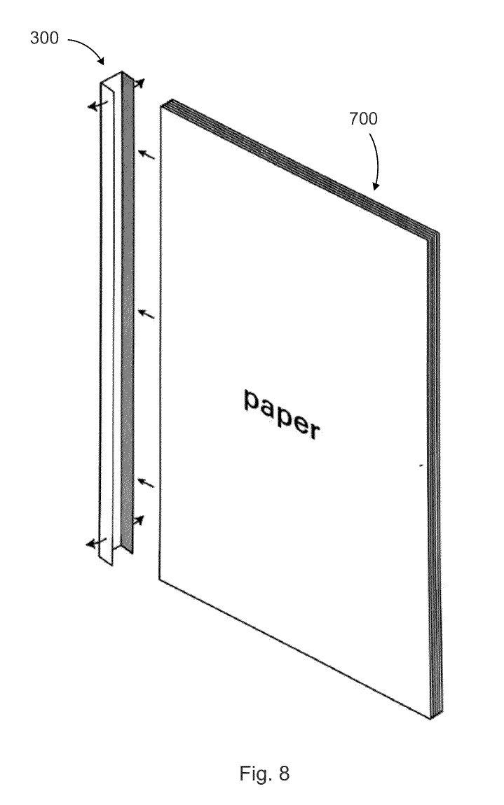

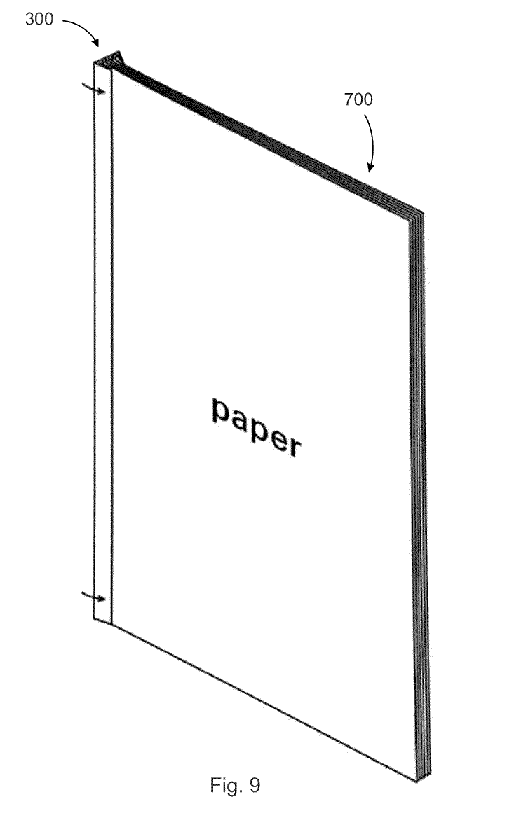

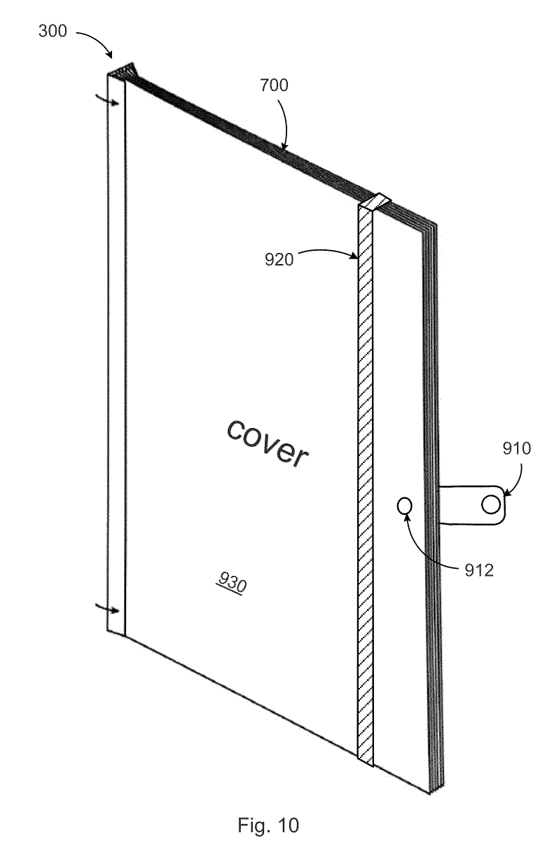

FIG. 5 illustrates various views of clamping rail 300 shown before, with exemplary geometrical configurations shown for these preferred embodiments. In FIG. 5(a), a cross section 500 of such clamping rail is illustrated. Dimensions are indicated in the FIG. 4 an exemplary preferred embodiment of such clamping rails, with the lateral extent of each of the center section 502 and side sections 504, 506 as well as the frontal opening 508 indicated. FIG. 5(b) illustrates a side view of a clamping rail 510 and shows an exemplary length 512 of such a rail. This length 512 is obviously variable in other embodiments and may be for example 11 inches or some other length. FIG. 5(c) illustrates a configuration of sheet stock such as stainless steel sheet stock from which the clamping rail is to be manufactured. In this embodiment, clamping rail 520 is to be folded twice so as to form three facets or sections thereof. A center section 524 is disposed between two side sections 522 and 526. All together, the sheet stock from which the clamping rail 520 is made has a width indicated by 530 and a length as shown previously. The sheet stock may be beveled, tapered, rounded or otherwise smoothed at its corners 525 so that they are not sharp. The two creases or folds are shown as dashed lines in FIG. 5(c) and may be manufactured using a sheet metal stamping machine or similar manufacturing apparatus. FIG. 6 illustrates a cross sectional view 600 of a clamping rail showing the flat center section 630 defining a closed end of the cross section 600 while an open end 640 opposes the center section 630. The dashed lines indicate the position of the clamping rail in its unloaded configuration (meaning its configuration before it is opened to accept any sheet material). Side sections 620 are forced outwardly to position 622 as shown to accept sheet stock or other objects to be clamped in the clamping rail 600. FIG. 7 illustrates a clamping rail 300 as described above and a plurality of sheets 700 such as loose leaf paper sheets that are to be inserted into the clamping rail. FIG. 8 illustrates opening of the side sections of clamping rail 300 to accommodate the plurality of sheet material 700. FIG. 9 illustrates the loaded configuration of the present binder where clamping rail 300 is allowed to exert inward force by the free edges of its side sections so as to grab and clamp the stack of sheet material 700 placed into the clamping rail. FIG. 10 illustrates an embodiment of the present binding system where a clamping rail 300 is loaded with a plurality of sheet material 700 including at least one cover sheet 930 that is placed around the plurality of sheet material 700. In the illustrated embodiment, a two-part fastener with one-part 910 of said two-part fastener attached to a belt can be connected to one cover such as the back cover of the bound materials, while a second part 912 of said two-part fastener can be attached another cover panel such as the front cover 930. Alternatively, an elastic or leather or fabric band 920 may be used to surround the closed sheet stock and covers to keep them in a closed configuration while not in use. When the user wishes to access the contents of the binder, he or she will remove the elastic or fabric band 920 or if the two-part fastener 910 and 912 is clasped, the user will unhook or unclasp this two-part fastener to access the inside of the binder.

Those skilled in the art will appreciate that cover 930 may be glued or otherwise attached to its corresponding side section of clamping rail 300 so as to form a permanent or semi permanent binder having a durable cover 930.

Of course, the dimensions of the apparatus may be modified to suit a particular purpose. For example, the closed (center section) end and/or the open end of the clamping rail may be modified to accept various thicknesses of materials and numbers of sheets. In some embodiments, the material thickness of the sheet stock from which the clamping rail is made may be modified so be durable and commensurate with the size of the objects being clamped. For example, the larger the clamping rail the larger its thickness can be made so as to be sufficiently durable and so as to apply a sufficient clamping force to the binder's contents.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications and equivalents.

What is claimed is:

1. A binder for mechanically securing one or more objects therein, comprising:
an elongated stress-operated clamping rail configured to have a tri-folded cross-section comprising a flat center section and two flat opposing side sections;
said side sections joined to said center section at a pair of respective elongated vertices defining respective outer edges of said center section and proximal edges of said side sections where said side sections meet said center section;
said side sections further having respective distal edges away from said center section separated by a natural gap when in an unloaded position such as when no objects are within said clamping rail; and
said tri-folded cross-section having an open end defined by said natural gap between said two distal edges of said side sections for receiving said objects, and an opposing closed end defined by said center section acting as a rigid spine of said clamping rail.

2. The binder of claim 1, said elongated clamping rail comprising a sheet material having a material rigidity sufficient to apply an inward mechanical clamping force to said objects once placed between in said clamping rail in its loaded position, wherein a loaded gap between the distal edges of said side sections when it is clamping said objects exceeds said natural gap when it is not clamping said objects.

3. The binder of claim 1, said elongated clamping rail comprising an elongated metal strip bent to form said elongated vertices where said center section and said side sections meet.

4. The binder of claim 1, said center section forming a substantially rectangular face of a spine of said binder that can be laid flat without rocking from side to side when said rectangular face of said center section is laid down on a supporting surface.

5. The binder of claim 1, said vertices comprising a cross-sectional angle between 45 degrees and 90 degrees measured between said center section and a side section.

6. The binder of claim 5, said vertices comprising a cross-sectional angle between 60 degrees and 90 degrees measured between said center section and a side section.

7. The binder of claim 1, further comprising a pair of cover panels attached to said respective two side sections, said cover panels moving in accordance with a movement of said side sheets when loading or unloading said binder.

8. The binder of claim 7, further comprising a mechanical closure temporarily securing said pair of cover panels relative to one another so that said binder remains in a closed position.

9. The binder of claim 8, said mechanical closure comprising an elastic band attached to one of said cover panels and configured to wrap around the other of said cover panels to hold said binder in said closed position.

10. The binder of claim 8, said mechanical closure comprising a two-part fastener with one part of said two-part fastener attached to a belt connected to a first one of said cover panels and a second part of said two-part fastener attached to the other of said cover panels.

11. The binder of claim 1, said clamping rail formed from three separate sections comprising said center section and said two side sections, wherein each of the center and side sections is formed of respective separate elongated flat stock pieces firmly joined to one another along the length of their elongated forms.

12. The binder of claim 1, said center section and said two side sections all being formed from a same flat piece of stock that is folded, bent or creased along two fold lines parallel to a length of said elongated clamping rail that define the center and side sections and that when folded, bent or creased form a tri-folded profile of three flat sections of said clamping rail.
